(19) United States
(12) Patent Application Publication
(10) Pub. No.: US 2025/0229438 A1
(43) Pub. Date: Jul. 17, 2025

(54) GRIPPING DEVICE

(71) Applicant: NTI AG, Spreitenbach (CH)

(72) Inventors: Ronald ROHNER, Remetschwil (CH); Ernst BLUMER, Zürich (CH)

(73) Assignee: NTI AG, Spreitenbach (CH)

(21) Appl. No.: 19/025,647

(22) Filed: Jan. 16, 2025

(30) Foreign Application Priority Data
Jan. 17, 2024 (EP) 24152378.6

(51) Int. Cl. B25J 15/02; B25J 9/16

(52) U.S. Cl. CPC B25J 15/0273; B25J 9/1612

(57) ABSTRACT

A gripping device comprises an electric linear motor having a motor stator and a motor slider which is movable in a longitudinal direction, a first gripper finger and a second gripper finger, a redirecting mechanism which is coupled to the motor slider as well as to at least one of the first and second gripper fingers, and a constant force generator having a stator and a slider which is movable relative to the stator in the longitudinal direction. The stator has a magnetically conductive or permanently magnetic stator region, and the slider has a permanently magnetic or magnetically conductive slider region. In a gripping position, the slider region and the stator region only partly overlap in the longitudinal direction, while in an open position, the slider region and the stator region do not overlap in the longitudinal direction.

The present invention relates to a gripping device according to claim 1. In particular, the invention relates to a gripping device having a tubular electric linear motor.

Gripping devices are used for the automated handling of items in a variety of industrial sectors. A widely used type of gripping device employs (at least) two gripper fingers for gripping an item, the gripper fingers gripping the item by interlocking or force-based engagement either by means of a parallel movement (parallel grippers) of the two gripper fingers towards one another or by means of a pincer movement (pivotal movement) of the two gripper fingers.

In order to provide as large as possible a gripping stroke while keeping installation space to a minimum, wide use is made of gripping devices having pneumatic cylinders with a direction of movement perpendicular to the direction of movement of the gripper fingers. Typically the direction of movement of the gripper fingers to grip the item is horizontal and the direction of movement of the pneumatic cylinder is vertical, the vertical movement of the pneumatic cylinder being redirected into the horizontal movement of the gripper fingers to grip the item by means of a redirecting mechanism.

Such pneumatic grippers have the disadvantage that in order to grip the item by interlocking engagement the gripping operation needs to be mechanically inhibited or the travel path of the gripper fingers mechanically restricted so that the force exerted by the gripper fingers is minimal when the gripper fingers interlockingly grip the item. In a case of where the item is gripped by force-based engagement, the gripping force is typically controlled by the air pressure in the pneumatic cylinder. In the case of a relatively small gripping force and a correspondingly low air pressure, the closing and opening times of the gripper fingers increase correspondingly. In addition, the position of the gripper fingers can be detected only by means of appropriate sensors, which requires the installation of additional electric lines alongside the pneumatic lines.

As an alternative to the pneumatic cylinders, the gripper fingers can be operated by a rotary electric motor, the rotary movement of the rotor of the rotary electric motor being redirected into the desired movement of the gripper fingers by a suitable (redirecting) transmission. In order to keep the required installation space small, a high gear ratio is typically chosen for the transmission, but this results in relatively slow travel or movement speeds and accordingly in relatively long opening and closing times of the gripper fingers. However, long opening and closing times of the gripper fingers can have a detrimental effect on the productivity of the system in which the gripping device is being used. Furthermore, in the case of gripping devices which are operated by means of a rotary electric motor, the force exerted can be determined and monitored only insufficiently accurately on account of the gear ratio.

In many applications it is necessary that the position of the gripper fingers or the gripping force be maintained in the event of a power failure. This is to prevent the possibility of the gripped item becoming detached from the gripper fingers and falling down, as this could result in damage to the gripped item and, for example in a case where the containers being gripped contain chemicals, lead to contamination. In such a case, when a gripper is operated by an electric motor, at least in the case of force-based gripping operations suitable measures must be taken to ensure that the gripper fingers in the gripping position apply the force necessary to be able to hold the item in the event of a power failure.

Against this background, the problem underlying the invention is to provide a gripping device which enables the above-mentioned disadvantages to be eliminated.

That problem is solved by a gripping device according to the invention, as defined by the features of independent claim 1. Especially advantageous developments and configurations of the gripping device according to the invention will be found in the dependent claims.

A gripping device according to the invention comprises
an electric linear motor, especially a tubular electric linear motor, having a motor stator and a motor slider which is movable relative to the motor stator in a longitudinal direction along a longitudinal axis of the motor slider,
a first gripper finger and a second gripper finger, the first gripper finger and the second gripper finger being movable relative to one another, and more specifically towards one another or away from one another, transversely with respect to the longitudinal direction,
a redirecting mechanism, which is coupled to the motor slider as well as to at least one of the first and second gripper fingers, for movement of the at least one of the first and second gripper fingers transversely with respect to the longitudinal direction as a result of a movement of the motor slider relative to the motor stator along the longitudinal axis of the motor slider. The gripping device further comprises
a constant force generator, having a stator and a slider which is movable relative to the stator in the longitudinal direction, and more specifically along a longitudinal axis of the slider;
   wherein
      the slider is fixedly connected to the motor slider and the stator is fixedly connected to the motor stator,
      the stator has a magnetically conductive or permanently magnetic stator region and the slider has a permanently magnetic or magnetically conductive slider region, and at least the stator region or the slider region is permanently magnetic and is magnetised in a magnetisation direction perpendicular to the longitudinal direction,
   and wherein the constant force generator is arranged relative to the motor stator and to the motor slider in such a way that
      in a gripping position of the first and second gripper fingers relative to one another, the slider and the stator are arranged in an active position in which the permanently magnetic or magnetically conductive slider region and the magnetically conductive or permanently magnetic stator region are arranged so as to only partly overlap in the longitudinal direction, to generate a force acting in the longitudinal direction from the slider to the redirecting mechanism to maintain the gripping position, and
      in an open position of the first and second gripper fingers relative to one another, the slider and the stator are arranged in an inactive position in which the permanently magnetic or magnetically conductive slider region and the magnetically conductive or permanently magnetic stator region are arranged so as not to overlap in the longitudinal direction, without generation of a force acting from the slider to the redirecting mechanism.

Electric linear motors directly generate a linear movement of the slider, without the need for transmissions or belts to convert a rotational movement, for example of the rotor of a rotary electric motor, into a linear movement. Accordingly, the gripping force exerted on the gripped item by the gripper fingers can be controlled and measured by the power of the motor directly by means of the motor current.

Both gripper fingers can be movable transversely with respect to the longitudinal direction, or alternatively thereto only the first or the second gripper finger, in which case the respective other gripper finger is then arranged so as to be immovable relative to the linear motor. A movement of the gripper fingers “transversely with respect to the longitudinal direction” includes both movements perpendicular to the longitudinal direction and those movements which depart from a movement perpendicular to the longitudinal direction and which also need not necessarily be rectilinear (for example, pivoting movements of the gripper fingers about a pivot axis).

The redirecting mechanism serves for converting the movement of the motor slider relative to the motor stator in the direction of the longitudinal axis of the motor slider into a relative movement of the first and second gripper fingers transversely with respect to the longitudinal direction. The redirecting mechanism can be coupled to either one of the first and second gripper fingers for movement of the first or the second gripper finger. Alternatively thereto, the redirecting mechanism can be coupled to both the first and the second gripper fingers, for movement of both the first gripper finger and the second gripper finger as a result of a movement of the motor slider relative to the motor stator in the direction of the longitudinal axis of the motor slider.

The constant force generator can exert a constant force from the stator (of the constant force generator) to the slider (of the constant force generator). A constant force generator is described, for example, in EP 1 378 986 A1. The constant force generator can have a permanently magnetic slider region and a magnetically conductive stator region. If the permanently magnetic slider region and the magnetically conductive stator region are arranged so as to overlap only partly (that is to say not fully) in the longitudinal direction, a longitudinal region of the permanently magnetic slider region protrudes from the magnetically conductive stator region. In the only partly overlapping arrangement, therefore, a longitudinal region of the permanently magnetic slider region overlaps a longitudinal region of the magnetically conductive stator region, while a longitudinal region of the permanently magnetic slider region that protrudes from the magnetically conductive stator region at one end of the stator does not overlap any part of the magnetically conductive stator region. As regards that longitudinal region of the permanently magnetic slider region which overlaps the magnetically conductive stator region, the magnetic flux generated by the permanently magnetic slider region is returned via the magnetically conductive stator region. The strength and the direction of the magnetisation is preferably constant over the length of the permanently magnetic slider region. Accordingly, in this case the magnetic conductivity (permeability) of the magnetically conductive stator region is also constant over its length. Due to the direction of magnetisation of the permanently magnetic slider region perpendicular to the longitudinal direction, accordingly no force acts on that longitudinal region of the slider which overlaps the magnetically conductive stator region in the longitudinal direction. At the longitudinal end of the magnetically conductive stator region at which the permanently magnetic slider region only partly overlaps the magnetically conductive stator region in the longitudinal direction, the total magnetic field, i.e. the effective magnetic field, is, however, inhomogeneous in respect of the longitudinal direction. The magnetic field declines in the direction pointing away from the said longitudinal end of the magnetically conductive stator region. As a result, the respective small longitudinal region of the permanently magnetic slider region which is located at the longitudinal end of the magnetically conductive stator region (but does not overlap the magnetically conductive stator region) is subjected to an attractive force which draws the permanently magnetic slider region in the direction towards the magnetically conductive stator region. Because that attractive force (irrespective of the longitudinal position of the slider relative to the stator) is exerted virtually always only on that small longitudinal region of the permanently magnetic slider region at the said longitudinal end of the magnetically conductive stator region (in which the resulting magnetic field is inhomogeneous in respect of the longitudinal direction), a force is generated by the constant force generator in the longitudinal direction, which force is constant irrespective of the longitudinal position of the slider relative to the stator as long as the permanently magnetic slider region does not fully overlap the magnetically conductive stator region. Accordingly, a constant attractive force is generated in the longitudinal direction, which force draws the slider of the constant force generator towards the stator.

Alternatively, the stator region can be permanently magnetic and the slider region can be magnetically conductive. Accordingly, in that case the strength and the direction of the magnetisation is preferably constant over the length of the permanently magnetic stator region. Correspondingly, in that case the magnetic conductivity (permeability) of the magnetically conductive slider region is also constant over its length. In that case too, an attractive force is generated in the longitudinal direction, which attractive force draws the slider of the constant force generator towards the stator. The above comments can therefore be applied correspondingly to that case. As a further alternative it is also possible for both the slider region and the stator region (that is to say both) to be permanently magnetic, with both directions of magnetisation being perpendicular to the longitudinal axis. To generate the attractive constant force, the two directions of magnetisation point in the same direction.

In contrast to gripping devices that are based on pneumatic cylinders, the use of the gripping device according to the invention enables the item to be gripped by interlocking engagement without it being necessary to adapt the travel path of the gripper fingers. The gripping device according to the invention further allows probing of the item to be gripped. For that purpose the gripper fingers are moved up to the item to be gripped until the gripper fingers touch the item. The movement of the gripper fingers is then stopped or the desired gripping force is adjusted.

The gripping device according to the invention also has the advantage that in the event of a power failure a sufficiently large gripping force of the gripper fingers can be maintained (namely by the force generated by the constant force generator). A situation where, for example, the gripping force is loosened due to a power failure while the item is being gripped by the gripper fingers and the gripped item is able to fall, can thus be avoided. This is because, by virtue of the constant force generator, a gripping force can be provided even if the power failure means that the linear motor cannot exert a force on the redirecting element and accordingly on the first and second gripper fingers.

The movement of the motor slider of the linear motor in the longitudinal direction (and accordingly transversely with respect to the direction of movement of the gripper fingers) has the advantage that the gripping device as a whole requires only a small amount of installation space transversely with respect to the longitudinal direction. Unlike gripping devices that are based on pneumatic cylinders, and also unlike gripping devices that are based on rotary electric motors, the gripping force can be controlled even at relatively low values without the travel speed and accordingly the opening and closing times of the gripper fingers being adversely affected. As a result of the high dynamic range of electric linear motors, the opening and closing times of the gripper fingers can be short in comparison with gripping devices having rotary electric motors or having pneumatic cylinders.

In accordance with an aspect of the gripping device according to the invention, the redirecting mechanism is coupled both to the first gripper finger and to the second gripper finger, for movement of both the first gripper finger and the second gripper finger transversely with respect to the longitudinal direction as a result of a movement of the motor slider relative to the motor stator along the longitudinal axis of the motor slider.

If both the first and the second gripper fingers are movable, the gripping device with the two gripper fingers can be moved to a location close to the item to be gripped, and in order to grip the item it is then only necessary for the two gripper fingers to be moved towards one another by the linear motor (and in co-operation with the constant force generator) in order to grip the item. If, however, the first or the second gripper finger is not movable (that is to say if only one of the two gripper fingers is movable, while the other is not movable), the gripping device must initially be arranged so that the non-movable gripping finger is already touching the item if movement of the item is to be avoided during the gripping operation. A gripping device in which each of the two gripper fingers (that is to say both the first and the second gripper fingers) is movable is accordingly considerably more flexible.

In accordance with a further aspect of the gripping device according to the invention, the constant force generator is arranged either at a first longitudinal end of the linear motor, at which the first gripper finger and the second gripper finger are also arranged, or at a second longitudinal end of the linear motor opposite to the first longitudinal end.

Such an arrangement of the constant force generator at one of the two longitudinal ends is advantageous in respect of the installation space required transversely with respect to the longitudinal direction (that is to say in the direction of movement of the gripper fingers). This is because an arrangement of the constant force generator at a longitudinal end of the linear motor enables the installation space required in the direction of movement of the gripper fingers to be minimised. In addition, this allows an arrangement of the slider of the constant force generator and of the motor slider along a common longitudinal axis (the longitudinal axis of the motor slider and of the slider of the constant force generator are coincident). This allows a direct transmission of force between the slider of the constant force generator and the motor slider of the linear motor as well as an extremely simple design, without complicated structural elements for force transmission.

In accordance with a further aspect of the gripping device according to the invention, the constant force generator is arranged at the first longitudinal end of the linear motor, at which the first gripper finger and the second gripper finger are also arranged. In the inactive position of the slider, the permanently magnetic or magnetically conductive slider region is arranged at a longitudinal end of the stator remote from the first longitudinal end of the linear motor so as not to overlap the magnetically conductive or permanently magnetic stator region.

Such an arrangement is advantageous in respect of the installation space required in the longitudinal direction. The constant force generator can be arranged in a space-saving manner (in the longitudinal direction) between the motor slider and the redirecting mechanism.

In accordance with a further aspect of the gripping device according to the invention, the slider region is permanently magnetic and is magnetised in a magnetisation direction perpendicular to the longitudinal direction, the stator region being magnetically conductive. This variant allows the arrangement of a flux concentrator at a longitudinal end of the permanently magnetic slider region of the slider of the constant force generator.

In accordance with a further aspect of the gripping device according to the invention, the constant force generator comprises such a flux concentrator made from a magnetically conductive material which is arranged at a longitudinal end of the permanently magnetic slider region of the slider of the constant force generator, which end faces towards the first longitudinal end of the linear motor.

In the active position of the stator and of the slider of the constant force generator, the flux concentrator is arranged so as to fully overlap the magnetically conductive stator region of the stator of the constant force generator in the longitudinal direction.

In the inactive position of the stator and of the slider of the constant force generator, the flux concentrator is arranged at a longitudinal end of the stator remote from the first longitudinal end of the linear motor so as not to overlap the magnetically conductive stator region of the stator in the longitudinal direction.

The flux concentrator consists of a magnetically conductive material of high permeability for as effective as possible concentration (guidance) of the magnetic flux.

As already mentioned, in the inactive position of the stator and slider of the constant force generator, the flux concentrator is arranged at a longitudinal end of the stator remote from the first longitudinal end of the linear motor so as not to overlap the magnetically conductive stator region of the stator in the longitudinal direction. In this configuration, the magnetic flux generated by the permanently magnetic slider region is guided (and returned) in the flux concentrator. As a result, a magnetic flux through the magnetically conductive stator region is avoided and accordingly an (attractive) force between the slider of the constant force generator and the stator of the constant force generator is more or less prevented or is not generated until the flux concentrator (having smaller dimensions in the longitudinal direction) enters the magnetically conductive region of the stator. In the active position of the stator and slider of the constant force generator (after the entry of the flux concentrator), the flux concentrator is then arranged so as to fully overlap the magnetically conductive stator region of the stator of the constant force generator in the longitudinal direction. That is to say, the magnetic flux generated by the permanently magnetic slider region is guided (and returned) via the magnetically conductive stator region, which results in the generation of the constant force on the slider in the longitudinal direction (as long as the permanently magnetic slider region only partly overlaps the magnetically conductive stator region, as already described above). With the aid of the flux concentrator it is thus possible to provide a very small transition region of longitudinal positions of the slider relative to the stator between the inactive position and the active position of the stator and slider of the constant force generator, which transition region can be reduced by up to about 90% (sharp, abrupt transition from the inactive position to the active position and vice versa) in comparison with a configuration without a flux concentrator.

In this way it can be achieved that the constant force generator generates the constant force actually only when the first and second gripper fingers are arranged in a (possible) gripping position or are almost in a gripping position, and otherwise does not generate a constant force.

In accordance with a further aspect of the gripping device according to the invention, the longitudinal axis of the motor slider is arranged vertically and the first longitudinal end of the linear motor is the lower end of the linear motor, at which the constant force generator and also the gripper fingers are arranged. The longitudinal axis of the slider of the constant force generator is likewise arranged vertically, and the longitudinal end of the stator of the constant force generator remote from the first longitudinal end of the linear motor is the lower end of the stator.

The vertical arrangement of the longitudinal axis of the motor slider and accordingly of the direction of movement of the motor slider allows the use of the gripping device in, for example, a pick-and-place application in which the item is gripped and, after being gripped, raised vertically before the gripping device, together with the gripped item, is moved in a horizontal direction by means of further actuators. The gripped item can then be set down in a predetermined target location. Particularly for such applications, it is advantageous for the installation space of the gripping device to be small in the horizontal direction (that is to say in the direction of movement of the gripper fingers).

In accordance with a further aspect of the gripping device according to the invention, the longitudinal axis of the motor slider of the linear motor and the longitudinal axis of the slider of the constant force generator are coincident.

Such an arrangement allows a simple, stable design that is particularly space-saving in the direction of movement of the gripper fingers. Furthermore, as already mentioned, this allows a direct transmission of the force from the motor slider and the slider of the constant force generator to the redirecting mechanism. The motor slider and the slider of the constant force generator can in that case be connected to one another to form a common slider.

In accordance with a further aspect of the gripping device according to the invention, the first gripper finger is arranged on a first gripper carriage and the second gripper finger is arranged on a second gripper carriage. The first gripper carriage and the second gripper carriage are movably arranged in a guide track, which is arranged in a transverse direction transverse with respect to the longitudinal direction, for movement of the first gripper finger and the second gripper finger towards one another or away from one another in the transverse direction by movement of the first gripper carriage and the second gripper carriage towards one another or away from one another in the guide track.

The arrangement of the two gripper fingers on the two gripper carriages enables the gripping device to be configured as a “parallel gripper”. This variant is suitable especially for applications in which, for example, the geometry of the item to be gripped or its arrangement on a support means that it is advantageous to move the gripper fingers towards the item along a predefined straight direction. This can be the case, for example, with items having a large contact surface with a particular orientation.

In accordance with a further aspect of the gripping device according to the invention, the redirecting mechanism comprises a first redirecting lever and a second redirecting lever. The first redirecting lever is coupled to the motor slider and to the first gripper carriage, for movement of the first gripper carriage with the first gripper finger arranged thereon in the guide track. The second redirecting lever is coupled to the motor slider and to the second gripper carriage, for movement of the second gripper carriage with the second gripper finger arranged thereon in the guide track.

The movement of the two gripper carriages by means of the redirecting levers allows a simple design of the redirecting mechanism. Since this configuration of the redirecting mechanism does not require gearwheels or belts, it is low-maintenance, reliable and cost-effective.

In accordance with a further aspect of the gripping device according to the invention, the redirecting mechanism has a first redirecting arm, which is coupled to the motor slider and is pivotable about a first pivot axis and is fixedly connected to the first gripper finger, as well as a second redirecting arm, which is coupled to the motor slider and is pivotable about a second pivot axis and is fixedly connected to the second gripper finger, for movement of the first gripper finger and the second gripper finger towards one another or away from one another by pivoting of the first redirecting arm about the first pivot axis and pivoting of the second redirecting arm about the second pivot axis.

The first and the second redirecting arms are, for example, each coupled at one end to the motor slider by means of a pin, and at the respective other end of the redirecting arm the respective gripper finger is fixedly connected to the redirecting arm. At that other end there is also arranged the respective pivot axis (for example a pivot pin) about which the respective redirecting arm is pivotable. As a result of the movement of the motor slider in the longitudinal direction, the two redirecting arms can then be pivoted about the respective pivot axes, so that the two gripper fingers perform a pincer-like movement. This configuration can be advantageous, for example, in applications in which the item is to be gripped at small, predetermined contact points.

As already mentioned, in the gripping device according to the invention the linear motor can be a tubular linear motor, the motor stator of which has an internal diameter and the motor slider of which has an external diameter that is smaller than the internal diameter of the motor stator. The stator of the (for example likewise tubular) constant force generator has an internal diameter and the slider of the constant force generator has an external diameter that is smaller than the internal diameter of the stator. The slider of the constant force generator and the motor slider are connected to one another by means of a circular-cylindrical connecting element made from a magnetically non-conductive material, the external diameter of which is smaller than the internal diameter of the stator of the constant force generator and likewise smaller than the internal diameter of the motor stator of the tubular linear motor, so that the connecting element is movable both into the stator of the constant force generator and into the motor stator.

Such a constant force generator has, in cross-section, a circular-cylindrical hollow profile (internal profile) of the stator and a corresponding circular-cylindrical external profile of the slider. These are very common forms of slider and stator, which are simple and reliable to produce (as is also the case with tubular linear motors). The connecting element allows a space-saving design. In particular, for gripping, the motor slider of the tubular linear motor can be moved into the motor stator to an extent such that the connecting element is also moved into the motor stator.

In accordance with a further aspect of the gripping device according to the invention, the connecting element is arranged between the motor slider and the flux concentrator.

The connecting element can be formed, for example, by an extension of a (non-magnetic) slider tube, the hollow space in that extension of the slider tube between the flow concentrator at the end of the permanently magnetic slider region of the constant force generator and the end of the motor slider of the linear motor being filled with potting compound.

In accordance with a further aspect of the gripping device according to the invention, the gripping device further comprises
a housing, wherein the motor stator of the linear motor is fixedly arranged in the housing,
a gripper head, wherein
   the first and second gripper fingers as well as the redirecting mechanism are arranged on the gripper head, and
   the gripper head, together with the first and second gripper fingers arranged thereon and with the redirecting mechanism, is rotatable relative to the housing about the longitudinal axis of the motor slider, and
a torque motor, comprising
   a torque motor stator arranged in the housing so as to be fixed against relative rotation,
   a torque motor rotor, which is connected to the gripper head so as to be fixed against relative rotation and is rotatable relative to the torque motor stator about the longitudinal axis of the motor slider, for rotation of the gripper head about the longitudinal axis of the motor slider.

This variant allows rotation (turning) of the gripper head and accordingly of the two gripper fingers about the longitudinal axis of the motor slider. This is advantageous insofar as the azimuth angle at which the gripper fingers are arranged in relation to the longitudinal axis of the motor slider is thereby adjustable. If, therefore, an item to be gripped has contact surfaces which the gripper fingers are to engage during the gripping operation, but those contact surfaces have a different azimuthal orientation from that of the gripper fingers, the gripper fingers can be moved in a simple way (that is to say with the aid of the torque motor) into the optimum azimuthal position for the gripping operation. For that purpose, only the relatively small mass of the gripper head needs to be rotated into the optimum azimuthal position (with the aid of the torque motor), which is quick and easy to achieve.

In accordance with a further aspect of the gripping device according to the invention, the gripping device further comprises a rotary coupling for coupling the redirecting mechanism arranged on the gripper head, which gripper head is rotatable about the longitudinal axis of the motor slider, to the motor slider, for transmission of the longitudinally acting force from the motor slider and/or from the slider of the constant force generator to the redirecting mechanism.

Such a rotary coupling allows rotation of the gripper fingers about the longitudinal axis of the motor slider, without it being necessary for the motor slider to be rotated relative to the motor stator in relation to the longitudinal axis. At the same time, such a rotary coupling allows the transmission of force in the longitudinal direction from the motor slider and from the slider of the constant force generator to the redirecting mechanism and accordingly ultimately to the gripper fingers.

Further advantageous aspects and configurations will be found in the following description of exemplary embodiments of the gripping device according to the invention or of parts thereof with the aid of the diagrammatic drawings, wherein:

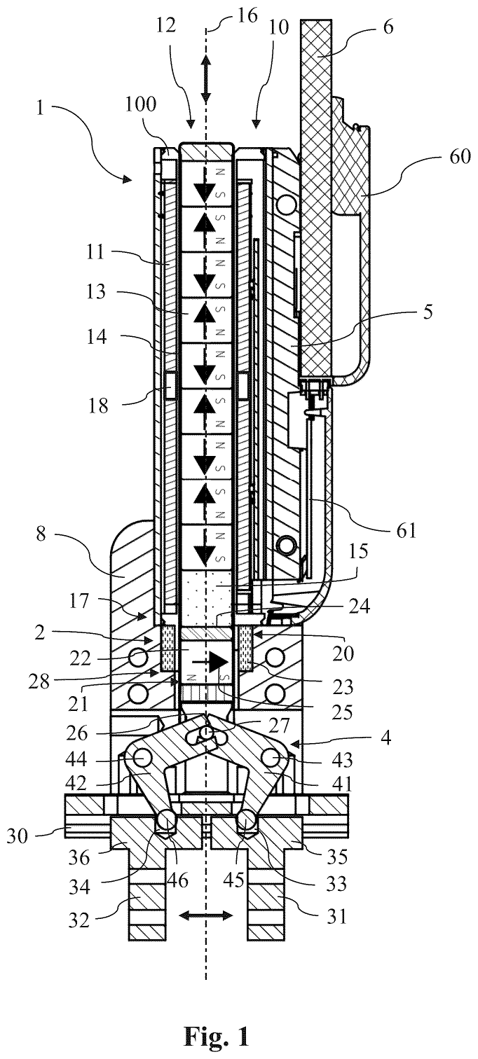

FIG. 1 shows a longitudinal section through a first exemplary embodiment of the gripping device according to the invention, with the gripper fingers in a gripping position (closed position);

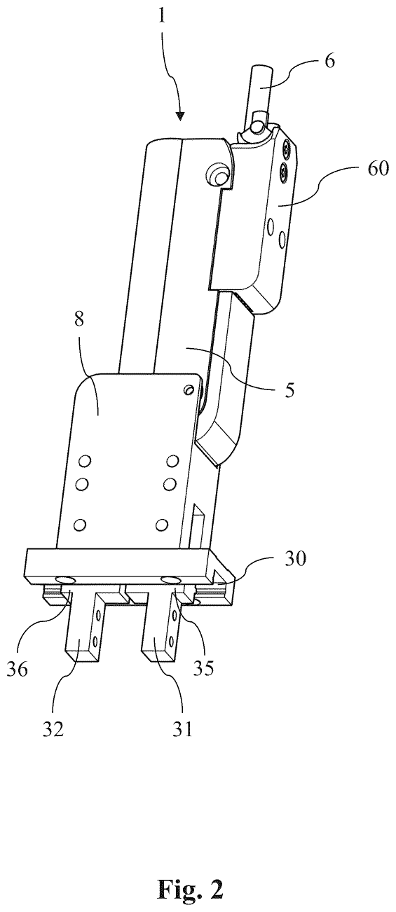

FIG. 2 shows a perspective view of the first exemplary embodiment of the gripping device from FIG. 1;

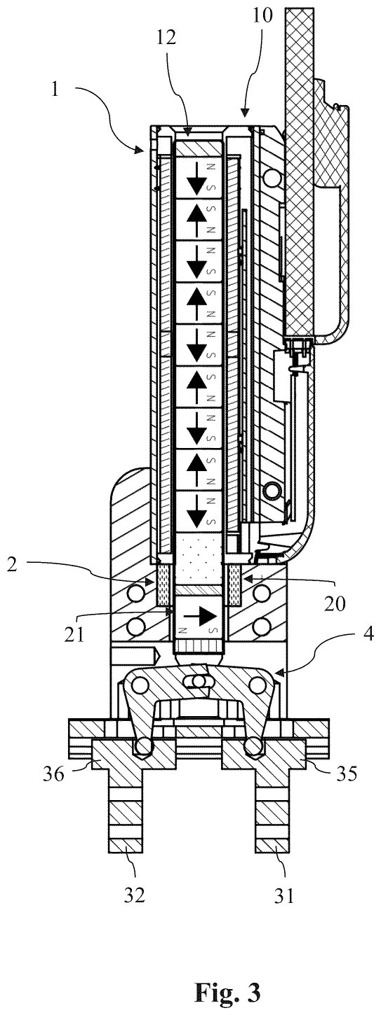

FIG. 3 shows a longitudinal section through the first exemplary embodiment of the gripping device from FIG. 1, with the gripper fingers in an intermediate position;

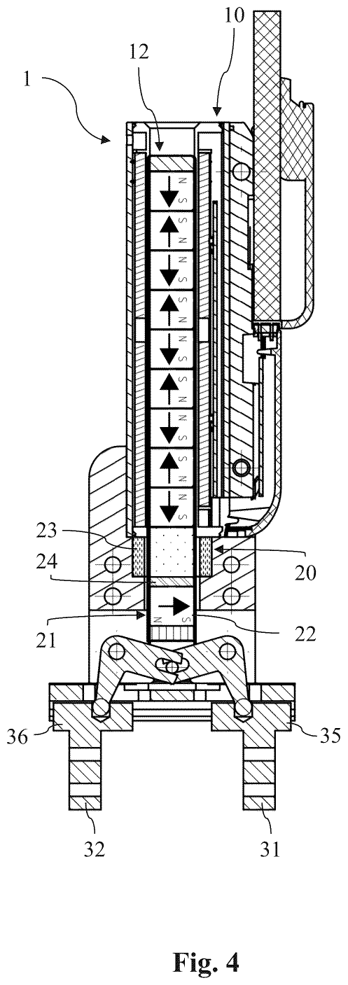

FIG. 4 shows a longitudinal section through the first exemplary embodiment of the gripping device from FIG. 1, with the gripper fingers in a fully open position;

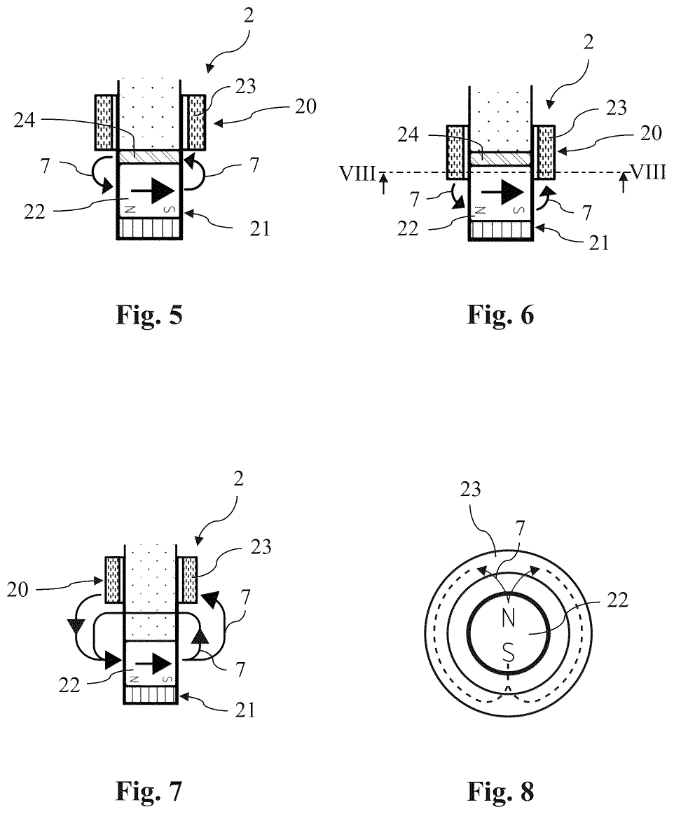

FIG. 5 shows a constant force generator having a flux concentrator, with the stator and the slider of the constant force generator in an inactive position;

FIG. 6 shows a constant force generator having a flux concentrator, with the stator and the slider of the constant force generator in an active position;

FIG. 7 shows a constant force generator not having a flux concentrator, with the stator and the slider of the constant force generator in an inactive position;

FIG. 8 shows a cross-section through the constant force generator along the line VIII-VIII in FIG. 6;

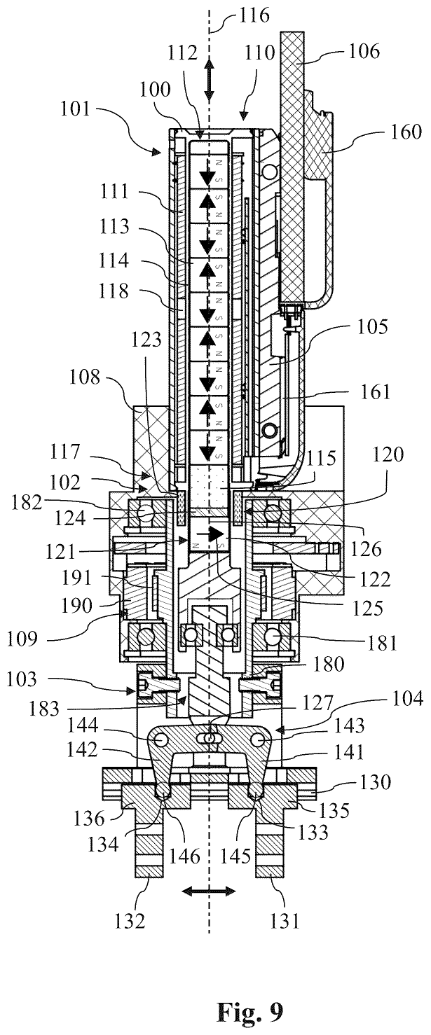

FIG. 9 shows a longitudinal section through a second exemplary embodiment of the gripping device according to the invention, with the gripper fingers in an intermediate position;

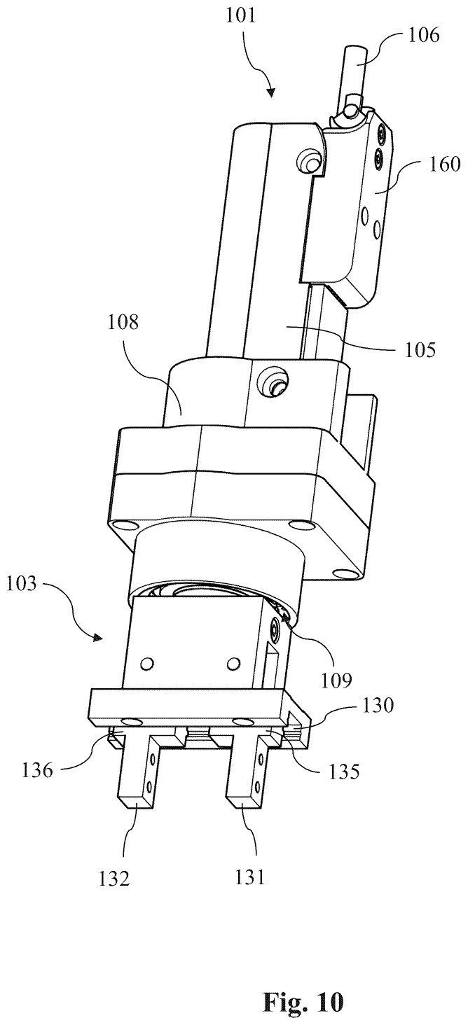

FIG. 10 shows a perspective view of the second exemplary embodiment of the gripping device from FIG. 9;

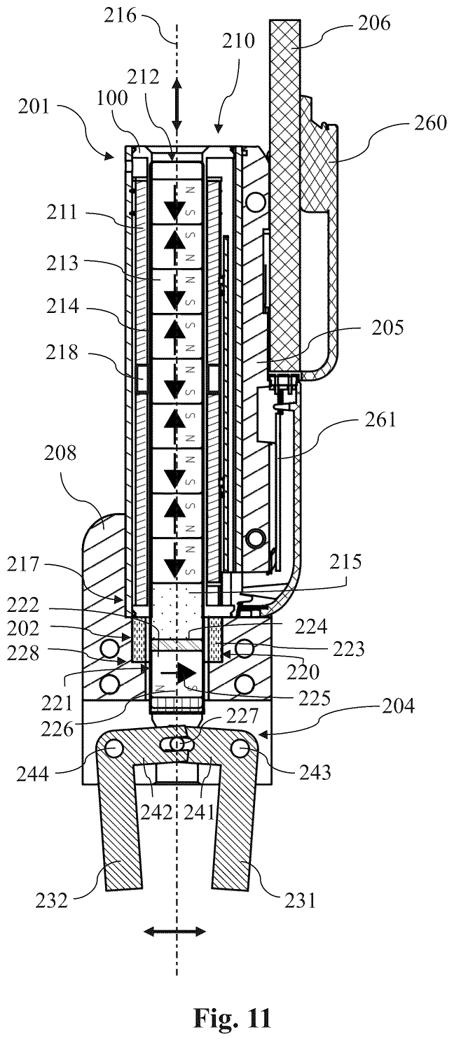

FIG. 11 shows a longitudinal section through a third exemplary embodiment of the gripping device according to the invention, with the gripper fingers in a gripping position; and

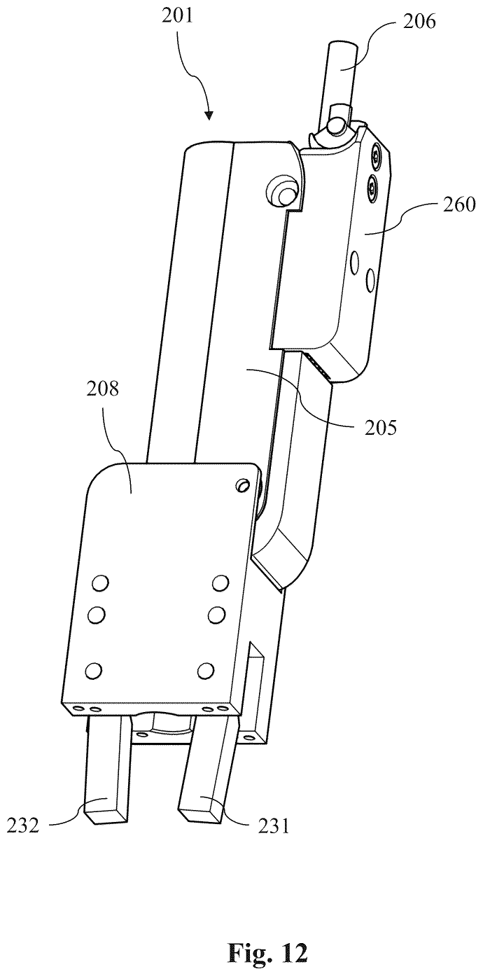

FIG. 12 shows a perspective view of the third exemplary embodiment of the gripping device from FIG. 11.

FIG. 1 shows a first exemplary embodiment of the gripping device according to the invention in longitudinal section and FIG. 2 shows a perspective view of the first exemplary embodiment of the gripping device according to the invention.

This first exemplary embodiment of the gripping device according to the invention comprises a tubular linear motor 1 having a motor stator 10 and a motor slider 12 with a vertically extending longitudinal axis 16. The motor stator 10 of the tubular linear motor 1 is arranged in a housing 5. It comprises a winding body 100 having an internal profile of circular-cylindrical cross-section and serves as sliding bearing for the motor slider 12 which has a circular-cylindrical external profile in cross-section, the external diameter of the motor slider 12 being slightly smaller than the internal diameter of the motor stator 10. The motor stator 10 further comprises drive windings 11 which are arranged around the winding body 100 (typically made from an abrasion-resistant plastics, for example PEEK) of the motor stator 10. The motor slider 12 has a plurality of disc magnets 13 which are arranged one after the other along the longitudinal axis 16 in a magnetically non-conductive slider tube 14 (for example made from aluminium or high-grade steel) of the motor slider 12. Optionally, it is also possible for iron discs to be inserted between the disc magnets 13 for flux optimisation. The drive windings 11 of the motor stator 10 can be energised via a cable 6, which is provided with a cable cover 60, and an electronic printed circuit board 61. By corresponding energisation of the drive windings 11, the motor slider 12 is movable relative to the motor stator 10 in a longitudinal direction along the longitudinal axis 16 (see double-headed arrow in FIG. 1). To detect the position of the motor slider 12 relative to the motor stator 10, the tubular linear motor 1 comprises a position sensor 18.

The gripping device further comprises a constant force generator 2. The constant force generator 2 has a stator 20 and a slider 21, the likewise vertically extending longitudinal axis 26 of which is coincident with the longitudinal axis 16 of the motor slider of the tubular linear motor 1. The slider 21 of the constant force generator 2 is movable relative to the stator 20 of the constant force generator in a longitudinal direction along the longitudinal axis 26. The slider 21 has a permanently magnetic slider region 22 which is magnetised in a magnetisation direction 25 perpendicular to the longitudinal axis 26 of the slider 21. The stator 20 has a magnetically conductive stator region 23. Similar to the tubular linear motor 1, the stator 20 of the constant force generator 2 has, in cross-section, a circular-cylindrical internal profile and the slider 21 of the constant force generator 2 has a circular-cylindrical external profile. The stator 20 has an internal diameter and the slider 21 has an external diameter that is smaller than the internal diameter of the stator 20.

The slider 21 of the constant force generator 2 is fixedly connected to the motor slider 12 of the linear motor 1. In this exemplary embodiment the permanently magnetic slider region 22 of the constant force generator 2 is fixedly connected to the motor slider 12 of the linear motor 1 via a connecting element 15 of circular-cylindrical cross-section. In the first exemplary embodiment shown, that connection is realised by the permanently magnetic slider region 22 being arranged in an extension of the magnetically non-conductive slider tube 14 of the motor slider 12 of the linear motor 1 and by the connecting element 15 being formed by a potting compound; in the exemplary embodiment shown, there is also a disc-shaped flux concentrator 24 made from a magnetically conductive material of high permeability arranged between the permanently magnetic slider region 25 and the potting compound. The function of the flux concentrator 24 is explained further hereinbelow.

The stator 20 of the constant force generator 2 is likewise fixedly connected to the motor stator 10 of the linear motor 1, namely via a housing part 8 which is fixedly connected to the housing 5, to which the motor stator 10 of the linear motor 1 is itself fixedly connected.

Generally, the external diameter of the connecting element 15 is (at least slightly) smaller than the internal diameter of the stator 20 of the constant force generator 2 and also (at least slightly) smaller than the internal diameter of the motor stator 10 of the linear motor 1 (which is automatically the case when it is formed as potting compound in the slider tube 14).

Accordingly, the connecting element 15 is able to move both into the stator 20 of the constant force generator 2 and into the motor stator 10 of the linear motor 1.

The constant force generator 2 is arranged at the lower longitudinal end 17 of the linear motor 1 and in FIG. 1 is shown in a gripping position (here: a closed position). The gripping position shown is one of the active positions in which the permanently magnetic slider region 22 and the magnetically conductive stator region 23 are arranged so as to overlap only partly (that is to say not fully) in the longitudinal direction, the permanently magnetic slider region 22 and the magnetically conductive stator region 23 of the constant force generator 2 being arranged so as to partly overlap at the lower longitudinal end 28 of the stator 20 of the constant force generator 2 remote from the lower longitudinal end 17 of the linear motor 1. In this active arrangement, the slider 21 is drawn upwards by the constant force of the constant force generator 2. In an active arrangement, the flux concentrator 24 is arranged so as to fully overlap the magnetically conductive stator region 23 in the longitudinal direction, so that the magnetic flux generated by the permanently magnetic slider region 22 passes through the magnetically conductive stator region 23, and the constant force generator 2 generates a constant force (upwards) in the longitudinal direction.

The gripping device further comprises a first gripper finger 31 and a second gripper finger 32. The first gripper finger 31 is arranged on a first gripper carriage 35 and the second gripper finger 32 is arranged on a second gripper carriage 36. The first gripper carriage 35 and the second gripper carriage 36 are arranged in a guide track 30 which is arranged in a transverse direction (see double-headed arrow) transverse with respect to the longitudinal direction (direction of the longitudinal axis 16, 26). The first gripper carriage 35 and the second gripper carriage 36 are movable towards one another and away from one another in the transverse direction along the guide track 30. Correspondingly, the first gripper finger 31 and the second gripper finger 32, which are arranged on the two gripper carriages 35, 36, are also movable towards one another and away from one another in the transverse direction.

The motor slider 12 and the slider 21 of the constant force generator 2 are coupled to a redirecting mechanism 4 at the lower end of the slider 21.

The redirecting mechanism 4 serves for movement of the first gripper carriage 35 and the second gripper carriage 36 as a result of a movement of the motor slider 12 of the linear motor 1 and of the slider 21 of the constant force generator 2 in the longitudinal direction relative to the motor stator 10 of the linear motor 1 and relative to the stator 20 of the constant force generator 2, respectively. The redirecting mechanism 4 comprises a first redirecting lever 41, which is mounted so as to be rotatable about a first redirecting pin 43, and a second redirecting lever 42, which is mounted so as to be rotatable about a second redirecting pin 44. The first redirecting lever 41 has at its lower end a first driver element 45 which in turn engages in a first receiver 33 of the first gripper carriage 35. Correspondingly, the second redirecting lever 42 has at its lower end a second driver element 46 which in turn engages in a second receiver 34 of the second gripper carriage 36.

The first redirecting lever 41 and the second redirecting lever 42 are coupled via a pin 27 to the slider 21 of the constant force generator 2 which is in turn fixedly connected to the motor slider 12. An upward movement of the motor slider 12 (and accordingly of the slider 21 of the constant force generator 2) results in opposite rotational movements of the first redirecting lever 41 and the second redirecting lever 42 about the pin 27, so that the first gripper carriage 35 and the second gripper carriage 36 are moved towards one another in the transverse direction. Correspondingly, the first gripper finger 31 and the second gripper finger 32 are also moved towards one another until the first gripper finger 31 and the second gripper finger 32 are arranged in the gripping position for gripping the items to be gripped.

Conversely, a downward movement of the motor slider 12 relative to the motor stator 10 in the longitudinal direction causes the first gripper finger 31 and the second gripper finger 32 to move away from one another until the first gripper finger 31 and the second gripper finger 32 are arranged in an open position.

FIG. 3 shows the gripping device from FIG. 1 in longitudinal section with the gripper fingers 31, 32 in an intermediate position, while FIG. 4 shows the gripping device in longitudinal section with the gripper fingers 31, 32 in a fully open position.

In comparison with the arrangement of the gripping device shown in FIG. 1, in the arrangement shown in FIG. 3 the motor slider 12 has been moved downwards relative to the motor stator 10. Correspondingly, the slider 21 fixedly connected to the motor slider 12 has also been moved downwards relative to the stator 20. The gripper carriages 35, 36 as well as the gripper fingers 31, 32 arranged thereon have accordingly been moved away from one another in the transverse direction. In the arrangement shown in FIG. 3 (intermediate position), the slider 21 and the stator 20 of the constant force generator 2 are still arranged in an active position. Accordingly, the slider 21 of the constant force generator 2 is still exerting a constant force on the redirecting mechanism 4.

In comparison with the arrangement shown in FIG. 3, in the arrangement shown in FIG. 4 the motor slider 12 has been moved further downwards relative to the motor stator 10. Correspondingly, the slider 21 fixedly connected to the motor slider 12 has also been moved further downwards relative to the stator 20. The gripper carriages 35, 36 as well as the gripper fingers 31, 32 arranged thereon have accordingly been moved away from one another in the transverse direction into the fully open position of the gripper fingers 31, 32. In FIG. 4 the stator 20 and the slider 21 of the constant force generator 2 are located in an inactive position. In this inactive position, the permanently magnetic slider region 22 with the flux concentrator 24 and the magnetically conductive stator region 23 are arranged so as not to overlap in the longitudinal direction. Accordingly, no force is exerted by the constant force generator 2 in the longitudinal direction from the slider 21 to the redirecting mechanism 4. The flux concentrator 24 is likewise arranged so as not to overlap the magnetically conductive stator region 23 in the longitudinal direction and prevents a build-up of leakage fluxes and therefore of a residual force between the magnetically conductive stator region 23 and the slider region 22.

The mode of operation of the flux concentrator 24 is explained in greater detail below with reference to FIG. 5 and FIG. 6.

In FIG. 5 the stator 20 and the slider 21 of the constant force generator 2 are arranged in the inactive position. The permanently magnetic slider region 22 is arranged so as not to overlap the magnetically conductive stator region 23 in the longitudinal direction. Furthermore, the flux concentrator 24 has also been moved downwards out of the stator 20 and is arranged so that it does not overlap the magnetically conductive stator region 23 at all in the longitudinal direction. Due to the high permeability of the flux concentrator 24, the magnetic flux of the magnetic field generated by the permanently magnetic slider region 22 (shown diagrammatically by the flux line 7) is guided and returned entirely through the flux concentrator 24. Any interaction between the permanently magnetic slider region 22 and the magnetically conductive stator region 23 is therefore avoided, with the result that in the inactive position no undesirable (attractive) forces act on the slider 21.

The situation is different in the active position, as shown in FIG. 6. Here the flux concentrator 24 is arranged so as to fully overlap the magnetically conductive stator region 23 in the longitudinal direction. Accordingly, the magnetic flux is returned through the magnetically conductive stator region 23. FIG. 8 shows the path of the magnetic flux for the portion of the permanently magnetic slider region 22 that is arranged so as to overlap the stator 20 (flux line 7 in FIG. 8). In the case of the portion of the permanently magnetic slider region 22 situated outside the stator 20, the return is effected as shown in FIG. 6 (flux line 7 in FIG. 6). In this way the stator 20 exerts an attractive force on the slider 21 (upwards) in the longitudinal direction.

In comparison therewith, FIG. 7 shows the situation without a flux concentrator 24. The stator 20 and the slider 21 are arranged in the inactive position, that is to say the permanently magnetic slider region 22 and the magnetically conductive stator region 23 are arranged so as not to overlap in the longitudinal direction. A major portion of the magnetic flux (see flux lines 7 in FIG. 7) is not returned via the magnetically conductive stator region 23.

A smaller portion of the magnetic flux (see flux lines 7) is, however, returned via the magnetically conductive stator region 23. This gives rise to a transition region at longitudinal positions of the slider 21 relative to the stator 20, in which region the force between the permanently magnetic slider region 22 and the magnetically conductive stator region 23 falls from full strength to zero. As a result of the flux concentrator 24, that transition region can be reduced by 80% to 90%, so that the constant force on the slider 21 takes effect more or less abruptly when the permanently magnetic slider region 22 and the magnetically conductive stator region 23 partly overlap in the longitudinal direction.

FIG. 9 shows a second exemplary embodiment of the gripping device according to the invention in longitudinal section, and FIG. 10 shows a perspective view of the second exemplary embodiment of the gripping device according to the invention. In the second exemplary embodiment, with the exception of the winding body 100 the other reference numerals for analogous components have been increased by one hundred with respect to the first exemplary embodiment from FIG. 1.

Accordingly, the second exemplary embodiment of the gripping device according to the invention comprises a tubular linear motor 101 having a motor stator 110 and a motor slider 112 with a vertically extending longitudinal axis 116. The motor stator 110 of the tubular linear motor 101 is arranged in a housing 105. It comprises a winding body 100 having an internal profile of circular-cylindrical cross-section and serves as sliding bearing for the motor slider 112 which has a circular-cylindrical external profile in cross-section, the external diameter of the motor slider 112 being (at least slightly) smaller than the internal diameter of the motor stator 110. The motor stator 110 further comprises drive windings 111 which are arranged around the winding body 100 (for example made from an abrasion-resistant plastics such as PEEK) of the motor stator 110. The motor slider 112 has a plurality of disc magnets 113 which are arranged one after the other along the longitudinal axis 116 in a magnetically non-conductive slider tube 114 (for example made from aluminium or high-grade steel) of the motor slider 112. The drive windings 111 of the motor stator 110 can be energised via a cable 106, which is provided with a cable cover 160, and an electronic printed circuit board 161. By corresponding energisation of the drive windings 111, the motor slider 112 is movable relative to the motor stator 110 in a longitudinal direction along the longitudinal axis 116 (see double-headed arrow in FIG. 9). To detect the position of the motor slider 112 relative to the motor stator 110, the tubular linear motor 101 comprises a position sensor 118.

The gripping device further comprises a constant force generator 102. The constant force generator 102 has a stator 120 and a slider 121, the likewise vertically extending longitudinal axis 126 of which is coincident with the longitudinal axis 116 of the motor slider 112 of the tubular linear motor 101. The slider 121 of the constant force generator 102 is movable relative to the stator 120 of the constant force generator 102 in a longitudinal direction along the longitudinal axis 126. The slider 121 has a permanently magnetic slider region 122 which is magnetised in a magnetisation direction 125 perpendicular to the longitudinal axis 126 of the slider 121. The stator 120 has a magnetically conductive stator region 123. Similar to the tubular linear motor 101, the stator 120 of the constant force generator 102 has, in cross-section, a circular-cylindrical internal profile and the slider 121 of the constant force generator 102 has a circular-cylindrical external profile. The stator 120 has an internal diameter and the slider 121 has an external diameter that is smaller than the internal diameter of the stator 120.

The slider 121 of the constant force generator 102 is fixedly connected to the motor slider 112 of the linear motor 101. In this exemplary embodiment, the permanently magnetic slider region 122 of the constant force generator 102 is fixedly connected to the motor slider 112 of the linear motor 101 via a connecting element 115 of circular-cylindrical cross-section. In the second exemplary embodiment shown, this connection is realised by the permanently magnetic slider region 122 being arranged in an extension of the magnetically non-conductive slider tube 114 of the motor slider 112 of the linear motor 101 and by the connecting element 115 being formed by a potting compound; in the exemplary embodiment shown, there is also a disc-shaped flux concentrator 124 made from a magnetically conductive material of high permeability arranged between the permanently magnetic slider region 125 and the potting compound. The function of the flux concentrator 124 is in principle the same as in the case of the flux concentrator 24 of the first exemplary embodiment and has already been explained above with reference to FIG. 5 to FIG. 8.

The stator 120 of the constant force generator 102 is likewise fixedly connected to the motor stator 110 of the linear motor 101, namely via a housing part 108 which is fixedly connected to the housing 105, to which the motor stator 110 of the linear motor 101 is also fixedly connected.

Generally, the external diameter of the connecting element 115 is (at least slightly) smaller than the internal diameter of the stator 120 of the constant force generator 102 and also (at least slightly) smaller than the internal diameter of the motor stator 110 of the linear motor 101 (which is automatically the case when it is formed as potting compound in the slider tube 114). Accordingly, the connecting element 115 is able to move both into the stator 120 of the constant force generator 102 and into the motor stator 110 of the linear motor 101.

The constant force generator 102 is arranged at the lower longitudinal end 117 of the linear motor 101, the permanently magnetic slider region 122 and the magnetically conductive stator region 123 of the constant force generator 102 being arranged so as to partly overlap (that is to say in an active arrangement) at the lower longitudinal end 128 of the stator 120 of the constant force generator 102 remote from the lower longitudinal end 117 of the linear motor 101. In this active arrangement, the slider 121 is drawn upwards by the constant force of the constant force generator 102.

The gripping device further comprises a first gripper finger 131 and a second gripper finger 132. The first gripper finger 131 is arranged on a first gripper carriage 135 and the second gripper finger 132 is arranged on a second gripper carriage 136. The first gripper carriage 135 and the second gripper carriage 136 are arranged in a guide track 130 which is arranged in a transverse direction (see double-headed arrow) transverse with respect to the longitudinal direction (direction of the longitudinal axis 116, 126). The first gripper carriage 135 and the second gripper carriage 136 are movable towards one another and away from one another in the transverse direction along the guide track 130. Correspondingly, the first gripper finger 131 and the second gripper finger 132, which are arranged on the two gripper carriages 135, 136, are also movable towards one another and away from one another in the transverse direction.

The motor slider 112 and the slider 121 of the constant force generator 102 are coupled to a redirecting mechanism 104 at the lower end of the slider 121. The redirecting mechanism comprises a first redirecting lever 141, which is mounted so as to be rotatable about a first redirecting pin 143, and a second redirecting lever 142, which is mounted so as to be rotatable about a second redirecting pin 144. The first redirecting lever 141 has at its lower end a first driver element 145 which in turn engages in a first receiver 133 of the first gripper carriage 135. Correspondingly, the second redirecting lever 142 has at its lower end a second driver element 146 which in turn engages in a second receiver 134 of the second gripper carriage 136.

Thus far the second exemplary embodiment of the gripping device according to the invention in accordance with FIG. 9 and FIG. 10 is largely analogous to the first exemplary embodiment, and the redirecting mechanism 104 itself is also basically constructed analogously to the redirecting mechanism of the first exemplary embodiment. Further description of the mode of operation of the analogous components of the second exemplary embodiment is therefore unnecessary. However, in the second exemplary embodiment the nature of the coupling of the redirecting mechanism 104 to the slider 121 of the constant force generator 102 is significantly different.

This is because, in the second exemplary embodiment, the gripper head 103 as a whole (including the previously described first and second gripper fingers 131, 132, including the guide track 130 and the first and second gripper carriages 135, 136 guided therein, and also including the redirecting mechanism 104) can be rotated relative to the motor slider 112 of the linear motor 101 about the longitudinal axis 116 thereof (and relative to the slider 121 of the constant force generator 102 about the longitudinal axis 126 thereof).

For that purpose, the second exemplary embodiment of the gripping device according to the invention has a torque motor 109, the torque motor stator 190 of which is fixedly connected to the housing 108, to which the stator 120 of the constant force generator 102 and the stator 110 (or the housing 105 thereof) of the linear motor 101 are also fixedly connected. Furthermore, the torque motor 109 has a torque motor rotor 191 which is fixedly arranged on a rotary shaft 180 (hollow shaft). The gripper head 103 is fixedly connected (for example screwed) to that rotary shaft 180. The rotary shaft 180 (hollow shaft) is in turn mounted by means of two ball bearings 181, 182 so as to be rotatable with respect to the housing 108. The gripper head 103 is rotatably coupled to the motor slider 112 of the linear motor 101 and to the slider 121 of the constant force generator 102 by means of a rotary coupling 183 (shaft section with a ball bearing).

If the torque motor rotor 191 of the torque motor 190 is set in rotation, the rotary shaft 180 (hollow shaft) rotates with the torque motor rotor 191 of the torque motor 190, with the result that the gripper head 103, which is fixedly connected to that rotary shaft 180, is also rotated, while neither the motor slider 112 of the linear motor 101 nor the slider 121 of the constant force generator 102 is rotated therewith (due to the gripper head 103 being coupled by means of the rotary coupling 183).

The first redirecting lever 141 and the second redirecting lever 142 of the redirecting mechanism 104 are coupled to the rotary coupling 183 (shaft section) via a pin 127. In respect of a movement in the direction of the longitudinal axis 116 of the linear motor 101 or in the direction of the longitudinal axis 126 of the constant force generator 102, the rotary coupling 183 is fixedly connected to the slider 121 of the constant force generator 102 which is in turn fixedly connected to the motor slider 112 of the linear motor 101.

In respect of the movement of the first redirecting lever 141 and the second redirecting lever 142 of the redirecting mechanism 104 by a movement of the motor slider 101 of the linear motor 101 along the longitudinal axis 116 and the resulting movement of the first gripper carriage 135 and the first gripper finger 131 and of the second gripper carriage 136 and the first gripper finger 132 towards one another or away from one another (double-headed arrow in FIG. 9), reference is made to the respective description of the first exemplary embodiment of the gripping device according to the invention.

FIG. 11 shows a third exemplary embodiment of the gripping device according to the invention in longitudinal section and FIG. 12 shows a perspective view of the third exemplary embodiment.

With the exception of the way in which the redirecting mechanism is configured (this is explained in greater detail hereinbelow) and accordingly the way in which the gripping movement of the first and second gripper fingers is effected (here: similarly to tongs), the third exemplary embodiment is configured analogously to the first exemplary embodiment. In the third exemplary embodiment the reference numerals have accordingly been increased by two hundred with respect to the reference numerals of the first exemplary embodiment.

Accordingly, the third exemplary embodiment of the gripping device according to the invention comprises a tubular linear motor 201 having a motor stator 210 and a motor slider 212 with a vertically extending longitudinal axis 216. The motor stator 210 of the tubular linear motor 201 is arranged in a housing 205. It comprises a winding body 100 having an internal profile of circular-cylindrical cross-section and serves as sliding bearing for the motor slider 212 which has a circular-cylindrical external profile in cross-section, the external diameter of the motor slider 212 being the same as (or slightly smaller than) the internal diameter of the motor stator 210. The motor stator 210 further comprises drive windings 211 which are arranged around the winding body 100 (for example made from an abrasion-resistant plastics such as PEEK) of the motor stator 210. The motor slider 212 has a plurality of disc magnets 213 which are arranged one after the other along the longitudinal axis 216 in a magnetically non-conductive slider tube 214 (for example made from aluminium or high-grade steel) of the motor slider 212. The drive windings 211 of the motor stator 210 can be energised via a cable 206, which is provided with a cable cover 260, and an electronic printed circuit board 261. By corresponding energisation of the drive windings 211, the motor slider 212 is movable relative to the motor stator 210 in a longitudinal direction along the longitudinal axis 216 (see double-headed arrow in FIG. 11). To detect the position of the motor slider 212 relative to the motor stator 210, the tubular linear motor 201 comprises a position sensor 218.

The gripping device further comprises a constant force generator 202. The constant force generator 202 has a stator 220 and a slider 221, the likewise vertically extending longitudinal axis 226 of which is coincident with the longitudinal axis 216 of the motor slider of the tubular linear motor 201. The slider 221 of the constant force generator 202 is movable relative to the stator 220 of the constant force generator 202 in a longitudinal direction along the longitudinal axis 226. The slider 221 has a permanently magnetic slider region 222 which is magnetised in a magnetisation direction 225 perpendicular to the longitudinal axis 226 of the slider 221. The stator 220 has a magnetically conductive stator region 223. Similar to the tubular linear motor 201, the stator 220 of the constant force generator 202 has, in cross-section, a circular-cylindrical internal profile and the slider 221 of the constant force generator 202 has a circular-cylindrical external profile. The stator 220 has an internal diameter and the slider 221 has an external diameter that is smaller than the internal diameter of the stator 220.

The slider 221 of the constant force generator 202 is fixedly connected to the motor slider 212 of the linear motor 201. In this exemplary embodiment, the permanently magnetic slider region 222 of the constant force generator 202 is fixedly connected to the motor slider 212 of the linear motor 201 via a connecting element 215 of circular-cylindrical cross-section. In the third exemplary embodiment shown, this connection is realised by the permanently magnetic slider region 222 being arranged in an extension of the magnetically non-conductive slider tube 214 of the motor slider 212 of the linear motor 201 and by the connecting element 215 being formed by a potting compound; in the exemplary embodiment shown, there is also a further disc-shaped flux concentrator 224 made from a magnetically conductive material of high permeability arranged between the permanently magnetic slider region 225 and the potting compound. The function of the flux concentrator 224 has already been explained hereinabove, so that reference is made to that explanation

The stator 220 of the constant force generator 202 is likewise fixedly connected to the motor stator 210 of the linear motor 201, namely via a housing 208 which is fixedly connected to the housing 205, to which the motor stator 210 of the linear motor 201 is itself fixedly connected.

Generally, the external diameter of the connecting element 215 is (at least slightly) smaller than the internal diameter of the stator 220 of the constant force generator 202 and also the same as or slightly smaller than the internal diameter of the motor stator 210 of the linear motor 201 (which is automatically the case when it is formed as potting compound in the slider tube 214). Accordingly, the connecting element 215 is able to move both into the stator 220 of the constant force generator 202 and into the motor stator 210 of the linear motor 201.

The constant force generator 202 is arranged at the lower longitudinal end 217 of the linear motor 201 and in FIG. 11 is shown in an intermediate position (analogous to FIG. 3). The intermediate position shown is one of the active positions in which the permanently magnetic slider region 222 and the magnetically conductive stator region 223 are arranged so as to overlap only partly (that is to say not fully) in the longitudinal direction, the permanently magnetic slider region 222 and the magnetically conductive stator region 223 of the constant force generator 202 being arranged so as to partly overlap at the lower longitudinal end 228 of the stators 220 of the constant force generator 202 remote from the lower longitudinal end 217 of the linear motor 201. In this active arrangement, the slider 221 is drawn upwards by the constant force of the constant force generator 202. In an active arrangement, the flux concentrator 224 is arranged so as to fully overlap the magnetically conductive stator region 223 in the longitudinal direction, so that the magnetic flux generated by the permanently magnetic slider region 222 passes through the magnetically conductive stator region 223 and the constant force generator 2 generates a constant force (upwards) in the longitudinal direction.

The third exemplary embodiment of the gripping device further comprises a first gripper finger 231 and a second gripper finger 232. The motor slider 212 of the linear motor 201 and the slider 221 of the constant force generator 202 are coupled to a redirecting mechanism 204 at the lower end of the slider 221. The redirecting mechanism 204 serves for movement of the first gripper finger 231 and the second gripper finger 232 as a result of a movement of the motor slider 212 relative to the motor stator 210 in the longitudinal direction.

Differently from the first exemplary embodiment, in the third exemplary embodiment the redirecting mechanism 204 comprises a first redirecting arm 241, which is pivotable about a first pivot pin 243 (which defines a first pivot axis), and a second redirecting arm 242, which is pivotable about a second pivot pin 244 (which defines a second pivot axis). The first gripper finger 231 is fixedly connected to the first redirecting arm 241 and the second gripper finger 232 is fixedly connected to the second redirecting arm 242.

Furthermore, the first redirecting arm 241 and the second redirecting arm 242 are connected via a (common) pin 227 to the slider 221 of the constant force generator 202 which is in turn fixedly connected to the motor slider 212 of the linear motor 201, with the result that the redirecting mechanism 204 is coupled to the motor slider 212 of the linear motor 201. An upward movement of the motor slider 212 of the linear motor 201 (and accordingly of the slider 221 of the constant force generator 202) results in opposite pivoting movements of the first redirecting arm 241 about the first pivot pin 243 and the second redirecting arm 242 about the second pivot pin 244, so that the first gripper finger 231 and the second gripper finger 232 are moved towards one another similarly to the gripping jaws of tongs. Correspondingly, the first gripper finger 231 and the second gripper finger 232 can be moved away from one another by a downward movement of the motor slider 212 relative to the motor stator 210 in the longitudinal direction until the first gripper finger 231 and the second gripper finger 232 are arranged in a fully open position. The double-headed arrow shown in FIG. 11 is accordingly intended to give only a diagrammatic indication of the movement of the first gripper finger 231 and the second gripper finger 232 towards one another and away from one another, because strictly speaking each gripper finger moves on a circular path about the respective pivot pin.

The gripping device according to the invention has been explained above with reference to exemplary embodiments. However, the invention is not limited to those exemplary embodiments, but is also intended to include configurations which make use of the technical teaching of the invention. The scope of protection is therefore defined by the following patent claims.

1. A gripping device, comprising
an electric linear motor, especially a tubular electric linear motor, having a motor stator and a motor slider which is movable relative to the motor stator in a longitudinal direction along a longitudinal axis of the motor slider,
a first gripper finger and a second gripper finger, the first gripper finger and the second gripper finger being movable relative to one another, and more specifically towards one another or away from one another, transversely with respect to the longitudinal direction,
a redirecting mechanism, which is coupled to the motor slider as well as to at least one of the first and second gripper fingers, for movement of the at least one of the first and second gripper fingers transversely with respect to the longitudinal direction as a result of a movement of the motor slider relative to the motor stator along the longitudinal axis of the motor slider, and
a constant force generator, having a stator and a slider which is movable relative to the stator in the longitudinal direction, and more specifically along a longitudinal axis of the slider;
wherein
the slider is fixedly connected to the motor slider and the stator is fixedly connected to the motor stator,
the stator has a magnetically conductive or permanently magnetic stator region and the slider has a permanently magnetic or magnetically conductive slider region, and at least the stator region or the slider region is permanently magnetic and is magnetised in a magnetisation direction perpendicular to the longitudinal direction,
and wherein the constant force generator is arranged relative to the motor stator and to the motor slider in such a way that
in a gripping position of the first and second gripper fingers relative to one another, the slider and the stator are arranged in an active position in which the permanently magnetic or magnetically conductive slider region and the magnetically conductive or permanently magnetic stator region are arranged so as to only partly overlap in the longitudinal direction, to generate a force acting in the longitudinal direction from the slider to the redirecting mechanism to maintain the gripping position, and
in an open position of the first and second gripper fingers relative to one another, the slider and the stator are arranged in an inactive position in which the permanently magnetic or magnetically conductive slider region and the magnetically conductive or permanently magnetic stator region are arranged so as not to overlap in the longitudinal direction, without generation of a force acting from the slider to the redirecting mechanism.

2. The gripping device according to claim 1, wherein the redirecting mechanism is coupled both to the first gripper finger and to the second gripper finger, for movement of both the first gripper finger and the second gripper finger transversely with respect to the longitudinal direction as a result of a movement of the motor slider relative to the motor stator along the longitudinal axis of the motor slider.

3. The gripping device according to claim 1, wherein the constant force generator is arranged either at a first longitudinal end of the linear motor, at which the first gripper finger and the second gripper finger are also arranged, or at a second longitudinal end of the linear motor opposite to the first longitudinal end.

4. The gripping device according to claim 3, wherein the constant force generator is arranged at the first longitudinal end of the linear motor, at which the first gripper finger and the second gripper finger are also arranged, and wherein in the inactive position of the slider the permanently magnetic or magnetically conductive slider region is arranged at a longitudinal end of the stator remote from the first longitudinal end of the linear motor so as not to overlap the magnetically conductive or permanently magnetic stator region.

5. The gripping device according to claim 4, wherein the slider region is permanently magnetic and is magnetised in a magnetisation direction perpendicular to the longitudinal direction, and wherein the stator region is magnetically conductive.

6. The gripping device according to claim 5, wherein the constant force generator further comprises a flux concentrator made from a magnetically conductive material which is arranged at a longitudinal end of the permanently magnetic slider region of the slider of the constant force generator, which end faces towards the first longitudinal end of the linear motor,
and wherein
in the active position of the stator and of the slider of the constant force generator, the flux concentrator is arranged so as to fully overlap the magnetically conductive stator region of the stator of the constant force generator in the longitudinal direction,
in the inactive position of the stator and of the slider of the constant force generator, the flux concentrator is arranged at a longitudinal end of the stator remote from the first longitudinal end of the linear motor so as not to overlap the magnetically conductive stator region of the stator in the longitudinal direction.

7. The gripping device according to claim 6, wherein the longitudinal axis of the motor slider is arranged vertically and the first longitudinal end of the linear motor is the lower end of the linear motor, at which the constant force generator and also the gripper fingers are arranged, and wherein the longitudinal axis of the slider of the constant force generator is likewise arranged vertically, and the longitudinal end of the stator of the constant force generator remote from the first longitudinal end of the linear motor is the lower end of the stator.

8. The gripping device according to claim 1, wherein the longitudinal axis of the motor slider of the linear motor and the longitudinal axis of the slider of the constant force generator are coincident.

9. The gripping device according to claim 8, wherein the first gripper finger is arranged on a first gripper carriage and the second gripper finger is arranged on a second gripper carriage, the first gripper carriage and the second gripper carriage being movably arranged in a guide track, which is arranged in a transverse direction transverse with respect to the longitudinal direction, for movement of the first gripper finger and the second gripper finger towards one another or away from one another in the transverse direction by movement of the first gripper carriage and the second gripper carriage towards one another or away from one another in the guide track.

10. The gripping device according to claim 9, wherein the redirecting mechanism comprises a first redirecting lever and a second redirecting lever, the first redirecting lever being coupled to the motor slider and to the first gripper carriage, for movement of the first gripper carriage with the first gripper finger arranged thereon in the guide track, and wherein the second redirecting lever is coupled to the motor slider and to the second gripper carriage, for movement of the second gripper carriage with the second gripper finger arranged thereon in the guide track.

11. The gripping device according to claim 8, wherein the redirecting mechanism has a first redirecting arm, which is coupled to the motor slider and is pivotable about a first pivot axis and is fixedly connected to the first gripper finger, and wherein the redirecting mechanism has a second redirecting arm, which is coupled to the motor slider and is pivotable about a second pivot axis and is fixedly connected to the second gripper finger, for movement of the first gripper finger and the second gripper finger towards one another or away from one another by pivoting of the first redirecting arm about the first pivot axis and pivoting of the second redirecting arm about the second pivot axis.

12. The gripping device according to claim 8, wherein the linear motor is a tubular linear motor, the motor stator of which has an internal diameter and the motor slider of which has an external diameter that is smaller than the internal diameter of the motor stator, and wherein the stator of the constant force generator has an internal diameter and the slider of the constant force generator has an external diameter that is smaller than the internal diameter of the stator, and wherein the slider of the constant force generator and the motor slider are connected to one another by means of a circular-cylindrical connecting element made from a magnetically non-conductive material, the external diameter of which is smaller than the internal diameter of the stator of the constant force generator and smaller than the internal diameter of the motor stator, so that the connecting element is movable both into the stator of the constant force generator and into the motor stator.

13. The gripping device according to claim 6, wherein the connecting element is arranged between the motor slider and the flux concentrator.

14. The gripping device according to claim 1, further comprising
a housing, wherein the motor stator of the linear motor is fixedly arranged in the housing,
a gripper head, wherein
the first and second gripper fingers as well as the redirecting mechanism are arranged on the gripper head, and
the gripper head, together with the first and second gripper fingers arranged thereon and with the redirecting mechanism, is rotatable relative to the housing about the longitudinal axis of the motor slider, and
a torque motor, comprising
a torque motor stator arranged in the housing so as to be fixed against relative rotation,
a torque motor rotor, which is connected to the gripper head so as to be fixed against relative rotation and is rotatable relative to the torque motor stator about the longitudinal axis of the motor slider, for rotation of the gripper head about the longitudinal axis of the motor slider.

15. The gripping device according to claim 14, further comprising a rotary coupling for coupling the redirecting mechanism arranged on the gripper head, which gripper head is rotatable about the longitudinal axis of the motor slider, to the motor slider, for transmission of the longitudinally acting force from the motor slider and/or from the slider of the constant force generator to the redirecting mechanism.
